(19) United States
(12) Patent Application Publication
(10) Pub. No.: US 2025/0267227 A1
(43) Pub. Date: Aug. 21, 2025

(54) IMAGE FORMING APPARATUS AND METHOD

(71) Applicants: Yuuta SAITOH, Tokyo (JP); Ryoh WATANABE, Kanagawa (JP)

(72) Inventors: Yuuta SAITOH, Tokyo (JP); Ryoh WATANABE, Kanagawa (JP)

(73) Assignee: Ricoh Company, Ltd., Tokyo (JP)

(21) Appl. No.: 19/029,314

(22) Filed: Jan. 17, 2025

(30) Foreign Application Priority Data
Feb. 20, 2024 (JP) 2024-023860

(51) Int. Cl. H04N 1/00

(52) U.S. Cl. CPC H04N 1/00896; H04N 1/00037; H04N 2201/0094

(57) ABSTRACT

An image forming apparatus includes a scanner control system, a plotter control system, a relay system, an operation unit, a detection unit, an energy-saving control unit, a determination unit, and a start control unit. The detection unit detects a predetermined trigger detected in at least one of the scanner control system, the plotter control system, and the operation unit. The energy-saving control unit shifts an operation status from a normal mode to an energy-saving mode in response to receiving an instruction to shift to the energy-saving mode. The determination unit receives the detected trigger, acquires a status of a first system associated with the detected trigger and a status of a second system associated with the first system. The start control unit receives information designating the first system and the second system when the second system is determined to be started, and controls the starting of the designated system.

### CROSS-REFERENCE TO RELATED APPLICATIONS

This patent application is based on and claims priority pursuant to 35 U.S.C. § 119 (a) to Japanese Patent Application No. 2024-023860, filed on Feb. 20, 2024, in the Japan Patent Office, the entire disclosure of which is hereby incorporated by reference herein.

### BACKGROUND

### Technical Field

The present disclosure relates to an image forming apparatus and a method.

### Related Art

In an image forming apparatus, a technique has been proposed for determining which portion of the image forming apparatus is to be returned from an energy-saving mode based on a trigger such as the opening and closing of a cover or the setting of a document or a printing sheet.

For example, an energy saving mode is continued, even when the user opens a cover of a document table to take out a read document after the user instructs the image forming apparatus to shift to the energy saving mode with the read document set on the document table and the image forming apparatus shifts to the energy saving mode, thus reducing time and effort of operation by the user.

### SUMMARY

The present disclosure described herein provides an image forming apparatus that includes a scanner control system, a plotter control system, a relay system, an operation unit, a detection unit, an energy-saving control unit, a determination unit, and a start control unit. The scanner control system controls a scanner. The plotter control system controls a plotter. The relay system controls the scanner control system and the plotter control system and relays a request from an external device. The operation unit has a panel.

The detection unit detects a predetermined trigger detected in at least one of the scanner control system, the plotter control system, and the operation unit. The energy-saving control unit shifts an operation status of the image forming apparatus from a normal mode to an energy-saving mode in response to receiving an instruction to shift to the energy-saving mode. The determination unit receives the detected trigger, acquires a status of a first system associated with the detected trigger and a status of a second system associated with the first system, and determines whether to start the second system in addition to the first system based on the status of the second system. The start control unit receives information designating the first system and the second system when the second system is determined to be started, and controls starting of the designated system and returning of the designated system from the energy-saving mode.

The present disclosure described herein provides an image forming apparatus that includes a scanner control system, a plotter control system, a relay system, an operation unit, and circuitry. The scanner control system controls a scanner. The plotter control system controls a plotter. The relay system controls the scanner control system and the plotter control system and relays a request from an external device. The operation unit has a panel.

The circuitry detects a predetermined trigger detected in at least one of the scanner control system, the plotter control system, and the operation unit. The circuitry shifts an operation status of the image forming apparatus from a normal mode to an energy-saving mode in response to receiving an instruction to shift to the energy-saving mode. In response to detection of the trigger, the circuitry acquires a status of a first system associated with the detected trigger and a status of a second system associated with the first system. The circuitry determines whether to start the second system in addition to the first system based on the status of the second system. The circuitry designates the first system and the second system when the second system is determined to be started. The circuitry controls starting of the designated system and returning of the designated system from the energy-saving mode.

The present disclosure described herein provides a method of controlling. The method includes detecting a predetermined trigger detected in at least one of a scanner control system, a plotter control system, and an operation unit. The method includes shifting an operation status of the image forming apparatus from a normal mode to an energy-saving mode in response to receiving an instruction to shift to the energy-saving mode. The method includes, in response to detection of the trigger, acquiring a status of a first system associated with the detected trigger and a status of a second system associated with the first system. The method includes determining whether to start the second system in addition to the first system based on the status of the second system. The method includes designating the first system and the second system when the second system is determined to be started. The method includes controlling starting of the designated system and returning of the designated system from the energy-saving mode.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an image forming apparatus according to an embodiment of the present disclosure;

FIG. 2 is a table illustrating an example of correspondence between a trigger and a main system;

FIG. 3 is a table illustrating an example of correspondence among a trigger, a main system, and a related system;

FIG. 4 is a flowchart illustrating an overview of an operation example of starting and returning from an energy-saving mode of an image forming apparatus;

FIG. 5 is a flowchart illustrating an operation example of acquiring a system to be started by a determination unit;

FIG. 6 is a flowchart illustrating an operation example of a determination process performed when a scanner control system is started;

FIG. 7 is a flowchart illustrating an operation example of a determination process performed when a plotter control system is started; and

FIG. 8 is a block diagram illustrating an example of a hardware configuration of an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the drawings for illustrating embodiments of the present disclosure, the same or like reference numerals are given to the components such as members and components having the same or like functions or shapes as long as they can be discriminated, and the description thereof will be omitted after the description is made once.

According to the present disclosure, in an image forming apparatus including a plurality of systems, the ease of use is enhanced in starting a system and returning from an energy-saving mode. Hereinafter, “starting a system and returning from an energy-saving mode” is also referred to as “starting and returning from an energy-saving mode” as appropriate.

An image forming apparatus according to an embodiment of the present disclosure includes a scanner control system, a plotter control system, and a relay system that relays the respective systems, and the relay system performs communication with an external device.

The scanner control system has an operation unit provided with a panel operated by a user.

The image forming apparatus determines a system to be started and to be returned from an energy-saving mode, based on not only a trigger at the time of starting and returning from an energy-saving mode but also the status of the image forming apparatus. This causes a user to quickly start using a function that the user wants to use, and causes a power consumption value to be appropriate.

A description is given below of an image forming apparatus according to an embodiment of the present disclosure.

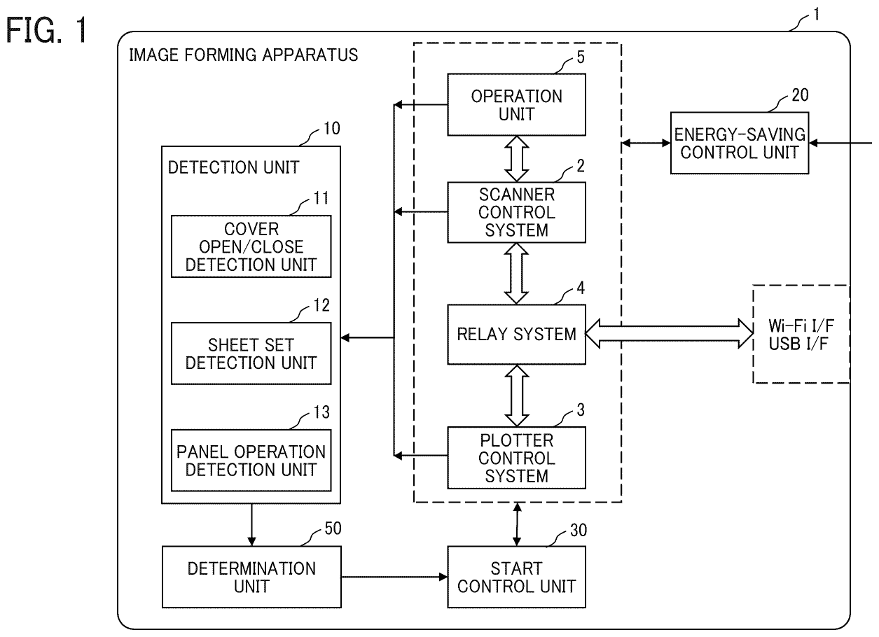

FIG. 1 is a diagram illustrating an example configuration of an image forming apparatus according to an embodiment of the present disclosure.

The image forming apparatus 1 includes a scanner control system 2 that controls a scanner, a plotter control system 3 that controls a plotter, a relay system 4 that controls the scanner control system 2 and the plotter control system 3 and relays a request from an external device, and an operation unit 5 having a panel. The operation unit 5 is connected to the scanner control system 2, and the panel is controlled by the scanner control system 2. The scanner and the plotter each have a structure that is generally known as that of any desired scanner and printer.

The scanner control system 2 and the relay system 4 are connected to each other via a scanner interface (SCN I/F).

The plotter control system 3 and the relay system 4 are connected to each other via a printer interface (PRN I/F).

The relay system 4 may be connected to, for example, an external device such as an information processing terminal and a recording medium via an interface such as a universal serial bus interface (USB I/F) and a wireless fidelity interface (Wi-Fi I/F).

The image forming apparatus 1 includes a detection unit 10, an energy-saving control unit 20, a start control unit 30, and a determination unit 50 as control units to control, for example, switching between a normal mode and the energy-saving mode and starting of each system for the above-described systems and the operation unit 5 surrounded by a broken line in FIG. 1.

The energy-saving mode is, for example, a status in which the image forming apparatus 1 is operated so as to reduce power consumption as compared to the normal mode.

The detection unit 10 detects a predetermined trigger (also referred to as “predetermined process”) that occurs in at least one of the scanner control system 2, the plotter control system 3, and the operation unit 5.

The detection unit 10 notifies the determination unit 50 of a predetermined trigger as a detection result.

The predetermined trigger may be at least one of the following processes, for example.

The opening and closing of a scanner cover of the scanner detected at the scanner control system 2, the opening and closing of a printer cover of the plotter detected at the plotter control system 3, the placing of a document on a table of the scanner detected at the scanner control system 2, the placing of a recording medium such as a printing sheet on a tray of the plotter detected at the plotter control system 3, and the operation on the panel included in the operation unit 5.

The detection unit 10 may include, for example, a cover open/close detection unit 11, a sheet set detection unit 12, and a panel operation detection unit 13.

The cover open/close detection unit 11 detects the opening and closing of a cover provided for the scanner control system 2 or the plotter control system 3.

The sheet set detection unit 12 detects that a document is set on a surface on which a document is to be set or a printing sheet is set at a position (place) at which a print sheet is to be set for the scanner control system 2 or the plotter control system 3.

The panel operation detection unit 13 detects that the panel of the operation unit 5 is operated.

The energy-saving control unit 20 shifts the operation status from the normal mode to the energy-saving mode when receiving an instruction to shift to the energy-saving mode.

The image forming apparatus 1 according to the present embodiment operates in, for example, either the normal mode in which normal power is used or the energy-saving mode in which power consumption is reduced.

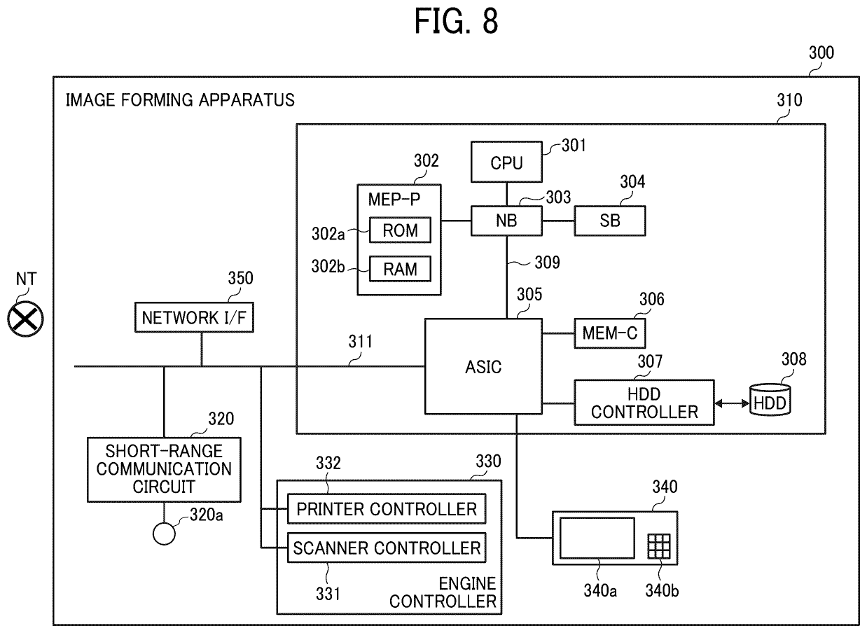

The information indicating whether the image forming apparatus 1 is operating in the normal mode or the energy-saving mode may be stored in a storage area that can be referred to by, for example, the control units included in the image forming apparatus 1. The storage area that can be referred to may be, for example, a system memory (MEM-P) 302 or a local memory (MEM-C) 306 in FIG. 8, which will be described later.

In the following description, the storage area that can be referred to by, for example, the control units is a storage area that can be read or written by, for example, the control units, and for example, the MEM-P 302, the MEM-C 306, a hard disk drive (HDD) 308 in FIG. 8 described below, or a detachable memory that can be read or written via an interface with the external device may be used.

When the detection unit 10 detects the execution of a predetermined trigger, the determination unit 50 receives the detected trigger as a detection result and acquires information about a main system associated with the detected trigger in advance. The main system is, for example, a system that is started when a trigger occurs among a plurality of systems included in the image forming apparatus 1, and is set in advance in association with the trigger. The determination unit 50 acquires the status of a related system associated with the main system in advance, and determines whether to start the related system based on the status of the related system. The determination unit 50 notifies the start control unit 30 of information (also referred to as “system starting information”) designating a system to be started (the main system and the related system, or only the main system). The main system and the related system may be referred to as a first system and a second system, respectively.

The determination unit 50 acquires the status of the related system, for example, based on the status of a signal line connected to each sensor.

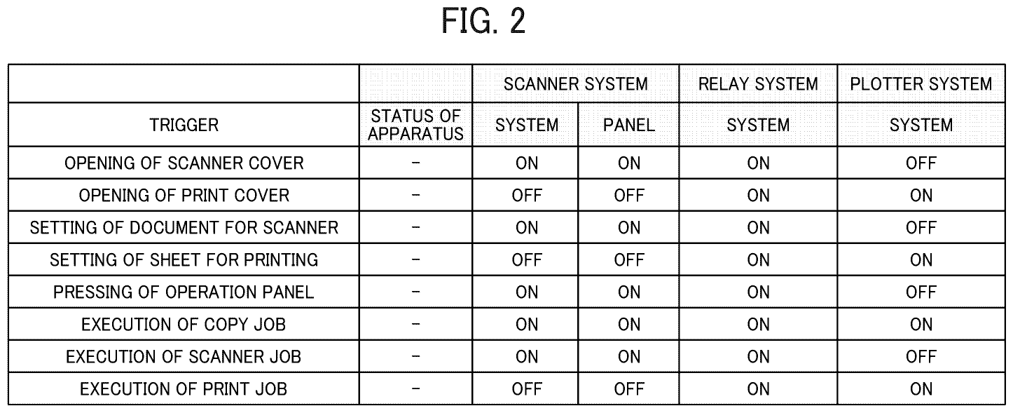

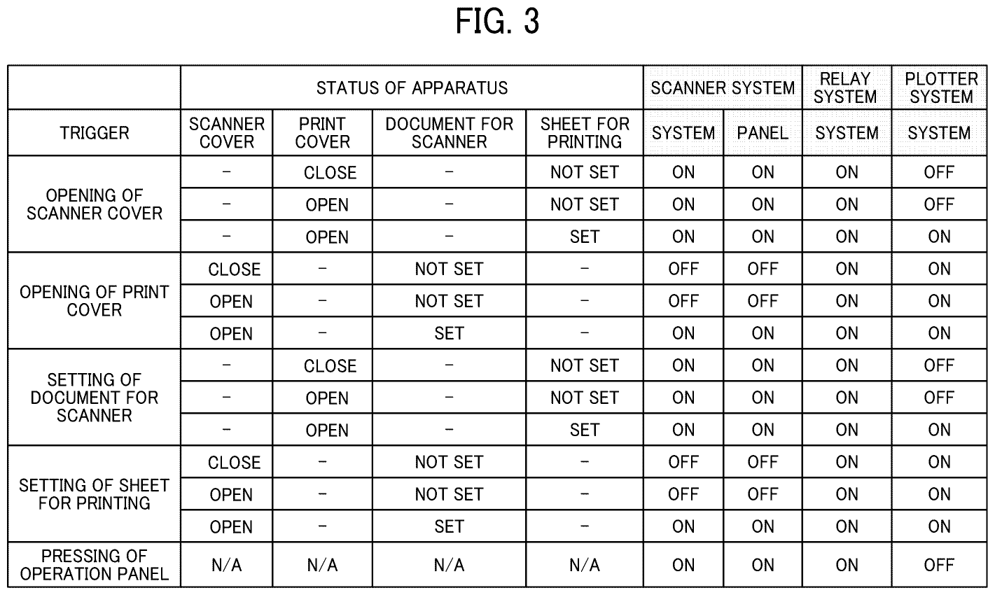

The determination unit 50 determines the main system, the statuses of the related systems, and the related system to be started, for example, based on the information illustrated in FIG. 2 and FIG. 3. The operation of the determination unit 50 will be described in detail later.

The start control unit 30 receives the system starting information from the determination unit 50, and controls the starting of the system designated by the system starting information and the returning from the energy-saving mode.

For example, the start control unit 30 performs control such that, when at least one of the main system and the related system operates in the energy-saving mode, the system operating in the energy-saving mode is returned from the energy-saving mode and is shifted to the normal mode, and when the main system and the related system operate in the normal mode, the system is not returned from the energy-saving mode.

An example of processing for determining the main system and the related system when a trigger occurs is described below.

The determination unit 50 determines whether to start the related system in addition to the main system associated with the trigger, based on the status of the related system.

FIG. 2 is a table illustrating an example of correspondence between the trigger and the main system. FIG. 2 illustrates a transition diagram in the case of not considering the status of the image forming apparatus 1. The relay system 4 is powered on in any status to control each system. The panel of the operation unit 5 is turned off during printing, but the panel is also turned on when “printing now” is displayed.

FIG. 3 is a table illustrating an example of correspondence between the trigger, the main system, and the related system. FIG. 3 illustrates a transition diagram in the case of considering the status of the image forming apparatus 1. The relay system 4 is powered on in any status to control each system. The panel of the operation unit 5 is turned off during printing, but the panel is also turned on when “printing now” is displayed. In consideration of the status of the image forming apparatus 1, when the cover is already opened or the document or the sheet is set, the power supplies of both the scanner control system 2 and the plotter control system 3 are turned on (to return the scanner control system 2 and the plotter control system 3 from an energy-saving mode).

In FIG. 3, the trigger that does not consider the status of the image forming apparatus 1 among the triggers illustrated in FIG. 2 is the pressing of the operation panel. Although the execution of a copy job, the execution of a scanner job, and the execution of a print job are not illustrated in FIG. 3, the same systems as those illustrated in FIG. 2 are started.

An example of operation from when the image forming apparatus 1 receives an instruction to save energy until when the image forming apparatus 1 returns is described below.

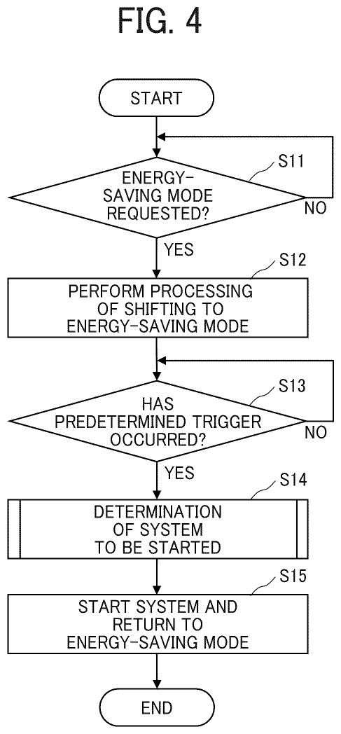

FIG. 4 is a flowchart illustrating an overview of an operation example of starting and returning from an energy-saving mode of the image forming apparatus 1.

The energy-saving control unit 20 is in a standby status until receiving an energy-saving mode shift request (NO in step S11). When receiving the shift request from the normal mode to the energy-saving mode (YES in step S11), in step S12, the energy-saving control unit 20 performs processing of shifting to the energy-saving mode.

After the shift to the energy-saving mode, the detection unit 10 waits until the detection unit 10 detects the occurrence of a predetermined trigger (NO in step S13). When detecting the predetermined trigger (YES in step S13), the detection unit 10 notifies the determination unit 50 of the detection result. In step S14, the determination unit 50 determines the system to be started (the main system and the related system, or only the main system) based on the detected trigger.

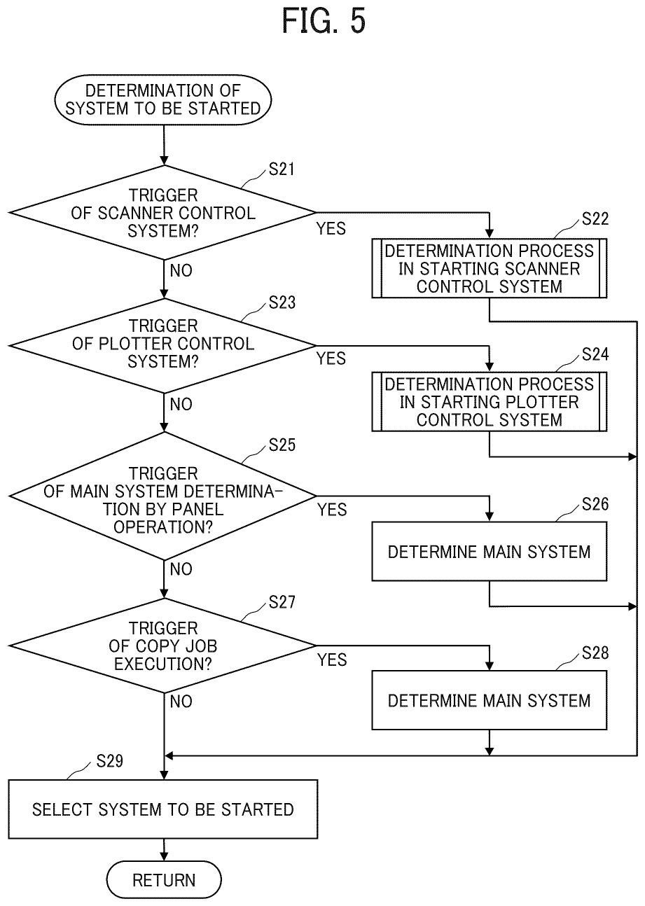

Step S14 will be described later with reference to FIGS. 5 to 7.

In step S15, the start control unit 30 controls starting of the system and returning from the energy-saving mode based on the information of the system to be started notified from the determination unit 50. At this time, if the system is not specified in the information of the system to be started, the operation is stopped without starting the system.

An operation example in which the determination unit 50 determines the system (the main system or the related system) to be started will be described with reference to FIGS. 5 to 7.

FIG. 5 is a flowchart illustrating an operation example of acquiring a system to be started by the determination unit 50.

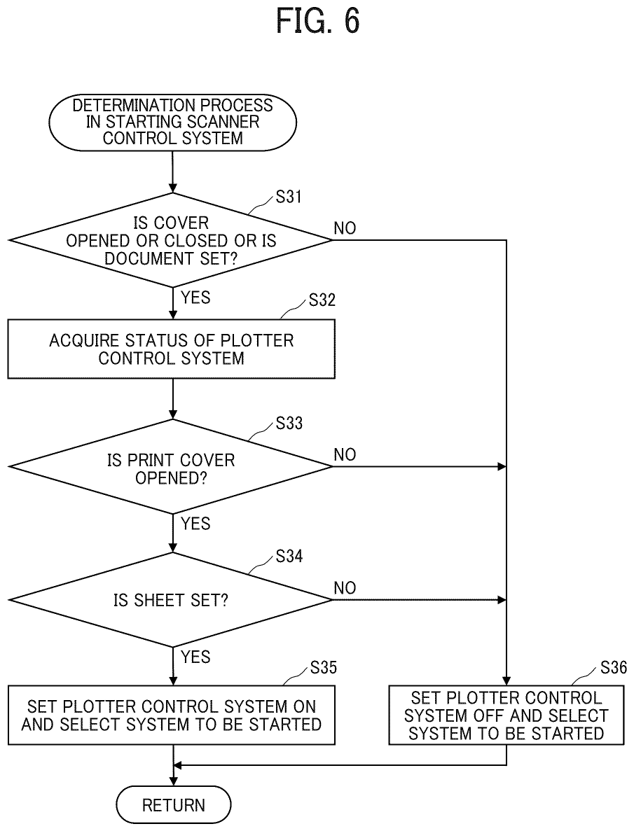

FIG. 6 is a flowchart illustrating an operation example of a determination process performed when the scanner control system 2 is started.

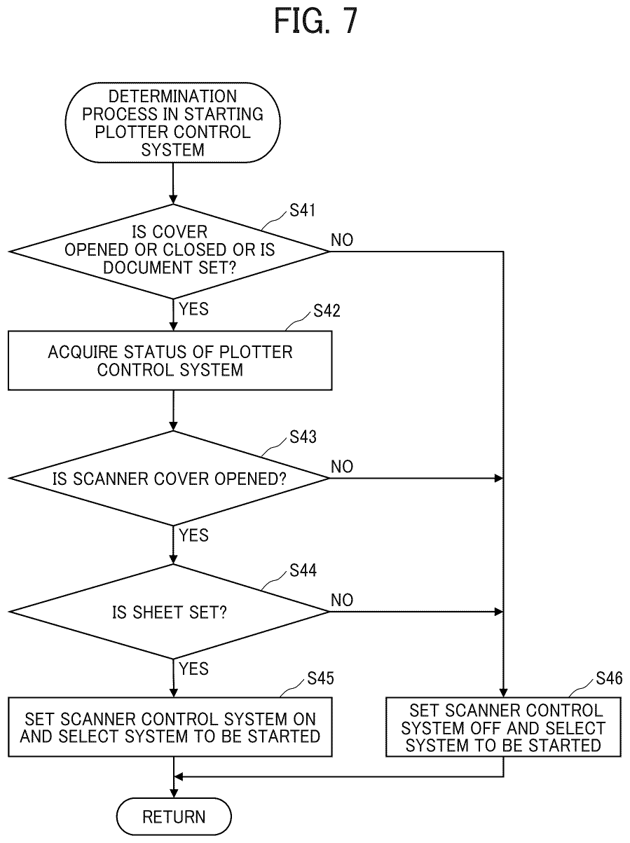

FIG. 7 is a flowchart illustrating an operation example of a determination process performed when the plotter control system 3 is started.

The determination unit 50 determines which system has generated the trigger detected by the detection unit 10 (which system the trigger relates to), and advances the processing.

When the trigger is a trigger of the scanner control system 2 (e.g., the opening of the scanner cover, the setting of a document for the scanner, or the execution of a scanner job) (YES in step S21), in step S22, the determination unit 50 performs a determination process at the time of starting of the scanner control system. The process of step S22 will be described later with reference to FIG. 6.

When the trigger is a trigger of the plotter control system 3 (e.g., the opening of a printer cover, the setting of a printing sheet, or the execution of a printer job) (YES in step S23), in step S24, the determination unit 50 performs a determination process at the time of starting of the scanner control system. The process of step S24 will be described later with reference to FIG. 7.

When the trigger is a panel operation of the operation unit 5 (e.g., the pressing of the panel) (YES in step S25), in step S26, the determination unit 50 designates the scanner control system 2, the panel of the operation unit 5, and the relay system 4 as the main system.

When the trigger is a trigger of executing the copy job (YES in S27), in step S28, the determination unit 50 designates all the systems of the scanner control system 2, the plotter control system 3, the panel of the operation unit 5, and the relay system 4 as the main systems.

In step S29, the determination unit 50 notifies the start control unit 30 of information designating the main system and the related system determined to be started or information designating the main system. As illustrated in FIG. 2 and FIG. 3, the main system or the related system determined to be started is one or more systems.

An operation example of the determination process performed by the determination unit 50 when the scanner control system 2 is started is described below with reference to FIG. 6.

In step S31, the determination unit 50 determines whether the trigger of the scanner control system 2 is the opening or closing of the cover or the setting of a document for the scanner. When the trigger is the opening or closing of the cover or the setting of a document (YES in step S31), in step S32, the determination unit 50 acquires the status of the plotter control system 3 as the status of the image forming apparatus 1.

When the determination unit 50 determines that the cover of the plotter control system 3 is opened (YES in step S33) and a document is set (YES in S34), the determination unit 50 determines to start the plotter control system 3. In step S35, the determination unit 50 determines the scanner control system 2, the panel of the operation unit 5, and the relay system 4 as the main system, and determines the plotter control system 3 as the related system.

In the other cases (NO in step S31, NO in step S33, or NO in step S34), in step S36, the determination unit 50 determines not to start the plotter control system 3, and determines the scanner control system 2, the panel of the operation unit 5, and the relay system 4 as the main system.

An example of the operation of the determination process performed by the determination unit 50 when the plotter control system 3 is started is described below with reference to FIG. 7.

In step S41, the determination unit 50 determines whether the trigger of the plotter control system 3 is the opening or closing of the cover or the setting of a sheet for printing. When the trigger is the opening or closing of the cover or the setting of a sheet (YES in step S41), in step S42, the determination unit 50 acquires the status of the scanner control system 2 as the status of the image forming apparatus 1.

When the determination unit 50 determines that the cover of the scanner control system 2 is opened (YES in step S43) and a document is set (YES in step S44), the determination unit 50 determines to start the scanner control system 2 and the panel of the operation unit 5. In step S45, the determination unit 50 determines the plotter control system 3 and the relay system 4 as the main system, and determines the scanner control system 2 and the panel of the operation unit 5 as the related system.

In the other cases (NO in step S41, NO in step S43, or NO in step S44), in step S46, the determination unit 50 determines not to start the scanner control system 2 and the panel of the operation unit 5, and determines the plotter control system 3 and the relay system 4 as the main system.

As illustrated in FIG. 6 and FIG. 7, when the detected trigger is either the opening or closing of the scanner cover or the setting of a scanner document, the determination unit 50 acquires the status of the opening or closing of the printer cover and the setting of a recording medium such as a printing sheet as the status of the related system, and determines whether to start the plotter control system 3 as the related system.

When the detected trigger is either the opening and closing of the printer cover or the setting of a recording medium, the determination unit 50 acquires the status of the opening or closing of the scanner cover and the setting of a scanner document as the status of the related system, and determines whether to start the scanner control system 2 as the related system.

When the determination unit 50 determines that the main system is the plotter control system 3, the determination unit 50 may designate the panel of the operation unit 5 as the related system or may not designate the panel of the operation unit 5 as the related system.

The plotter control system 3 may be configured to be compatible with a system displayed on the panel and a system not displayed on the panel when the plotter control system 3 is operated.

As described above, when the image forming apparatus 1 detects a trigger, the image forming apparatus 1 starts a system directly corresponding to the trigger, returns from the energy-saving mode, and starts a system related to the main system. In this way, a system to be started and returned from the energy-saving mode is determined in consideration of not only the trigger at the time of starting and returning from the energy-saving mode but also the status of the image forming apparatus 1. Thus, the use of the function desired by the user is started quickly, and an appropriate power consumption value is set. Such a configuration can reduce the user's time and effort and enhance the usability when the system is started or returned from the energy-saving mode based on the trigger.

### Modification

In the above-described embodiments, the determination unit 50 determines the main system associated with a predetermined trigger. For example, the image forming apparatus 1 may store information in the table illustrated in FIG. 2 and FIG. 3 in a storage area that can be referred to by the determination unit 50 in advance, and the determination unit 50 may proceed with the process with reference to the table. As an example, the image forming apparatus 1 may include a storing unit that stores information in the table. When determining the system to be started and returned from the energy-saving mode and the related system related to the main system, the determination unit 50 may determine the main system and the related system by referring to, for example, information in a table stored in advance in the storing unit.

In the configuration in which the information in the table is stored in, for example, the storing unit, the information in the table may be changed via, for example, the operation unit 5 or an external information processing apparatus. Accordingly, the user can flexibly change the starting of the system and the returning from the energy-saving mode according to a using situation.

In the above-described embodiments, the control units may each be implemented by, for example, a program or a combination of a program and hardware. Specifically, the detection unit 10 may be implemented by a processor such as a CPU that operates according to a control program, and operates in cooperation with various sensors. The determination unit 50, the energy-saving control unit 20, and the start control unit 30 may each be implemented by the processor such as the CPU that operates according to the control program.

Next, an example of a hardware configuration of the image forming apparatus described in each of the above exemplary embodiments will be described using an image forming apparatus 300 with reference to FIG. 8. FIG. 8 is a block diagram illustrating an example of a hardware configuration of the image forming apparatus 300.

The image forming apparatus 300 includes, for example, a multifunction peripheral/product/printer (MFP). The image forming apparatus 300 includes a controller 310, a short-range communication circuit 320, an engine controller 330, an operation panel 340, and a network I/F 350.

The controller 310 controls the entire operation of the image forming apparatus 300 and controls, for example, drawing, communication, and input from the operation panel 340. The controller 310 includes a central processing unit (CPU) 301 as a main processor, a system memory (MEM-P) 302, a north bridge (NB) 303, a south bridge (SB) 304, an application-specific integrated circuit (ASIC) 305, the MEM-C 306 as a storage device, an HDD controller 307, and a hard disk (HD) 308 as a storage device. The NB 303 and the ASIC 305 are connected through an accelerated graphics port (AGP) bus 309.

The CPU 301 controls the entire operation of the image forming apparatus 300.

The NB 303 connects the CPU 301 to the MEM-P 302, the SB 304, and the AGP bus 309. The NB 303 includes a memory controller that controls reading or writing of various data from or to the MEM-P 302, a peripheral component interconnect (PCI) master, and an AGP target.

The MEM-P 302 includes a read-only memory (ROM) 302a as a memory that stores programs and data for implementing various functions of the controller 310. The MEM-P 302 further includes a random-access memory (RAM) 302b as a memory that deploys the programs and data, or as a drawing memory that stores drawing data for printing.

The program stored in the ROM 302a may be stored in any computer-readable recording medium, such as a compact disc-read-only memory (CD-ROM), compact disc-recordable (CD-R), or digital versatile disc (DVD), in an installable or executable file format for distribution.

The SB 304 is a bridge that connects the NB 303 to PCI devices and peripheral devices.

The ASIC 305 is an integrated circuit (IC) dedicated to image processing and includes hardware elements for image processing. The ASIC 305 serves as a bridge to connect the AGP bus 309, a PCI bus 311, the HDD 308, and the MEM-C 306 to each other.

The ASIC 305 includes a PCI target, an AGP master, an arbiter (ARB) as a central processor of the ASIC 305, a memory controller for controlling the MEM-C 306, a plurality of direct memory access controllers (DMACs) capable of converting coordinates of image data with a hardware logic, and a PCI unit that transfers data between a scanner controller 331 and a printer controller 332 through the PCI bus 311.

The ASIC 305 may be connected to a universal serial bus (USB) interface, or the Institute of Electrical and Electronics Engineers 1394 (IEEE1394) interface.

The MEM-C 306 is a local memory used as a buffer for an image to be copied or a buffer for coding.

The HDD 308 is a storage for storing image data, font data used in printing, and forms. The HDD controller 307 controls the reading or writing data from or to the HDD 308 under the control of the CPU 301.

The AGP bus 309 is a bus interface for a graphics accelerator card, which has been proposed to accelerate graphics processing. Through directly accessing the MEM-P 302 by high throughput, the speed of the graphics accelerator card increases.

The short-range communication circuit 320 is provided with a short-range communication antenna 320a. The short-range communication circuit 320 is a communication circuit that communicates in compliance with a near field communication (NFC) or the BLUETOOTH (registered trademark), for example.

The engine controller 330 includes the scanner controller 331 and the printer controller 332. The scanner controller 331 or the printer controller 332 includes an image processing unit such as error diffusion processing and gamma conversion processing. For example, the scanner controller 331 may function as a control section of the scanner control system 2, and the printer controller 332 may function as a control section of the plotter control system 3.

The operation panel 340 includes a panel display 340a and an operation panel 340b. The panel display 340a is implemented by, for example, a touch panel that displays current settings or a selection screen to receive a user input. The operation panel 340b includes a numeric keypad that receives set values of various image forming parameters such as image density parameter and a start key that receives an instruction for starting copying.

The operation panel 340 may be used as a panel included in the operation unit 5 illustrated in FIG. 1, and the operation panel 340 may be managed by the scanner control system 2 as illustrated in, for example, FIG. 1.

In response to an instruction to select a specific application through the operation panel 340, for example, using a mode switch key, the image forming apparatus 300 selectively performs a document box function, a copier function, a printer function, and a facsimile function. When the document box function is selected, the image forming apparatus 300 operates in a document box mode. When the copier function is selected, the image forming apparatus 300 operates in a copy mode. When the printer function is selected, the image forming apparatus 300 operates in a printer mode. When the facsimile function is selected, the image forming apparatus 300 operates in a facsimile mode.

The network I/F 350 is an interface for performing data communications using a communication network NT. The short-range communication circuit 320 and the network I/F 350 are electrically connected to the ASIC 305 through the PCI bus 311. In one example, the network I/F 350 or the short-range communication circuit 320 may perform at least a part of functions provided by the relay system 4.

When a cover is opened or a document or sheet is set in advance, a user may erroneously use a desired function. For example, when a scanner cover is opened in a device which has been shifted to an energy-saving mode with a printing sheet set therein, only a scanner unit is returned from the energy-saving mode. As a result, for example, copying cannot be immediately performed, and it may take time to start copying.

The present disclosure provides an image forming apparatus having a plurality of systems, which enhances the ease of use in starting a system and returning from an energy-saving mode.

According to the present disclosure, in an image forming apparatus including a plurality of systems, the ease of use is enhanced in starting a system and returning from an energy-saving mode.

Some aspects of the present disclosure are described below.

Aspect 1 An image forming apparatus includes a scanner control system, a plotter control system, a relay system, an operation unit, a detection unit, an energy-saving control unit, a determination unit, and a start control unit. The scanner control system controls a scanner. The plotter control system controls a plotter. The relay system controls the scanner control system and the plotter control system and relays a request from an external device. The operation unit has a panel.

The detection unit detects a predetermined trigger generated in at least one of the scanner control system, the plotter control system, and the operation unit. The energy-saving control unit shifts an operation status from a normal mode to an energy-saving mode when receiving an instruction to shift to the energy-saving mode. The determination unit receives a detected trigger, acquires a status of a main system associated with the detected trigger in advance and a status of a related system associated with the main system in advance, and determines whether to start the related system based on the status of the related system. The start control unit receives information designating the main system and the related system determined to be started, and controls starting of a system designated by the information and returning from the energy-saving mode.

### Aspect 2

In the image forming apparatus according to Aspect 1, the detected trigger is one of opening and closing of a scanner cover included in the scanner control system, opening and closing of a printer cover included in the plotter control system, placing of a document on the scanner control system, placing of a recording medium on the plotter control system, and operation of the panel included in the operation unit.

When the detected trigger is one of the opening and closing of the scanner cover and the placing of the document, the determination unit acquires a status of the opening and closing of the printer cover and the placing of the recording medium on the plotter control system as the status of the related system, and determines whether to start the plotter control system as the related system.

When the detected trigger is one of the opening and closing of the printer cover and the placing of the recording medium, the determination unit acquires a status of the opening and closing of the scanner cover and the placing of the document on the scanner control system as the status of the related system, and determines whether to start the scanner control system as the related system.

### Aspect 3

In the image forming apparatus according to Aspect 1 or Aspect 2, the determination unit designates the panel to the related system when the determination unit determines that the main system is the plotter control system.

### Aspect 4

In the image forming apparatus according to any one of Aspects 1 to 3, the determination unit does not designate the panel to the related system when the determination unit determines that the main system is the plotter control system.

The present disclosure is not limited to the above-described embodiments. Within the scope of the present disclosure, each element of the above-described embodiments can be changed, added, or converted to content that can be easily conceived by those skilled in the art.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a scanner control system to control a scanner;
a plotter control system to control a plotter;
a relay system to control the scanner control system and the plotter control system and relay a request from an external device;
an operation unit having a panel;
a detection unit to detect a predetermined trigger detected in at least one of the scanner control system, the plotter control system, and the operation unit;
an energy-saving control unit to shift an operation status of the image forming apparatus from a normal mode to an energy-saving mode in response to receiving an instruction to shift to the energy-saving mode;
a determination unit to receive the detected trigger, acquire a status of a first system associated with the detected trigger and a status of a second system associated with the first system, and determine whether to start the second system in addition to the first system based on the status of the second system; and
a start control unit to receive information designating the first system and the second system when the second system is determined to be started, and control starting of the designated system and returning of the designated system from the energy-saving mode.

2. The image forming apparatus according to claim 1,
wherein the detected trigger is one of opening and closing of a scanner cover detected at the scanner control system, opening and closing of a printer cover detected at the plotter control system, placing of a document detected at the scanner control system, placing of a recording medium detected at the plotter control system, and operating the panel included in the operation unit,
wherein when the detected trigger is one of the opening and closing of the scanner cover and the placing of the document, the determination unit determines the scanner control system as the first system, acquires a status of opening and closing of the printer cover and placing of the recording medium as the status of the second system, and determines whether to start the plotter control system as the second system, and
wherein when the detected trigger is one of the opening and closing of the printer cover and the placing of the recording medium, the determination unit determines the plotter control system as the first system, acquires the status of the opening and closing of the scanner cover and the placing of the document as the status of the second system, and determines whether to start the scanner control system as the second system.

3. The image forming apparatus according to claim 1,
wherein the determination unit designates the panel to the second system when the determination unit determines that the first system is the plotter control system.

4. The image forming apparatus according to claim 1,
wherein the determination unit does not designate the panel to the second system when the determination unit determines that the first system is the plotter control system.

5. An image forming apparatus comprising:
a scanner control system to control a scanner;
a plotter control system to control a plotter;
a relay system to control the scanner control system and the plotter control system and relay a request from an external device;
an operation unit having a panel;
circuitry configured to:
detect a predetermined trigger detected in at least one of the scanner control system, the plotter control system, and the operation unit;
shift an operation status of the image forming apparatus from a normal mode to an energy-saving mode in response to receiving an instruction to shift to the energy-saving mode;
in response to detection of the trigger, acquire a status of a first system associated with the detected trigger and a status of a second system associated with the first system;
determine whether to start the second system in addition to the first system based on the status of the second system;
designate the first system and the second system when the second system is determined to be started, and
control starting of the designated system and returning of the designated system from the energy-saving mode.

6. The image forming apparatus according to claim 5,
wherein the detected trigger is one of opening and closing of a scanner cover detected at the scanner control system, opening and closing of a printer cover detected at the plotter control system, placing of a document detected at the scanner control system, placing of a recording medium detected at the plotter control system, and operating the panel included in the operation unit,
wherein when the detected trigger is one of the opening and closing of the scanner cover and the placing of the document, the circuitry determines the scanner control system as the first system, acquires a status of opening and closing of the printer cover and placing of the recording medium as the status of the second system, and determines whether to start the plotter control system as the second system, and
wherein when the detected trigger is one of the opening and closing of the printer cover and the placing of the recording medium, the circuitry determines the plotter control system as the first system, acquires the status of the opening and closing of the scanner cover and the placing of the document as the status of the second system, and determines whether to start the scanner control system as the second system.

7. The image forming apparatus according to claim 5,
wherein the circuitry designates the panel to the second system when the circuitry determines that the first system is the plotter control system.

8. The image forming apparatus according to claim 5,
wherein the circuitry does not designate the panel to the second system when the circuitry determines that the first system is the plotter control system.

9. A method of controlling, comprising:
detecting a predetermined trigger detected in at least one of a scanner control system, a plotter control system, and an operation unit;
shifting an operation status of the image forming apparatus from a normal mode to an energy-saving mode in response to receiving an instruction to shift to the energy-saving mode;
in response to detection of the trigger, acquiring a status of a first system associated with the detected trigger and a status of a second system associated with the first system;
determining whether to start the second system in addition to the first system based on the status of the second system;
designating the first system and the second system when the second system is determined to be started; and
controlling starting of the designated system and returning of the designated system from the energy-saving mode.
